(19) United States
(12) Patent Application Publication
(10) Pub. No.: US 2002/0087617 A1
(43) Pub. Date: Jul. 4, 2002

(54) Method for distributing project information

(76) Inventor: Robert L. Fortney, Cleveland, OH (US)

Correspondence Address: PEARNE & GORDON LLP, 526 SUPERIOR AVENUE EAST, SUITE 1200, CLEVELAND, OH, 44114-1484, US

(21) Appl. No.: 09/752,048

(22) Filed: Dec. 29, 2000

(51) Int. Cl. G06F 15/16

(52) U.S. Cl. 709/201

(57) ABSTRACT

A method for distributing project information includes posting respective project information from a plurality of sponsors on an international public computer communications network, permitting a subscriber to access selected portions of the respective project information to determine a desired sponsor and a desired portion of the respective project information, registering a subscriber with the desired sponsor for distribution of the desired portions of the respective project information and permitting the registered subscriber to access the desired portions of the respective project information.

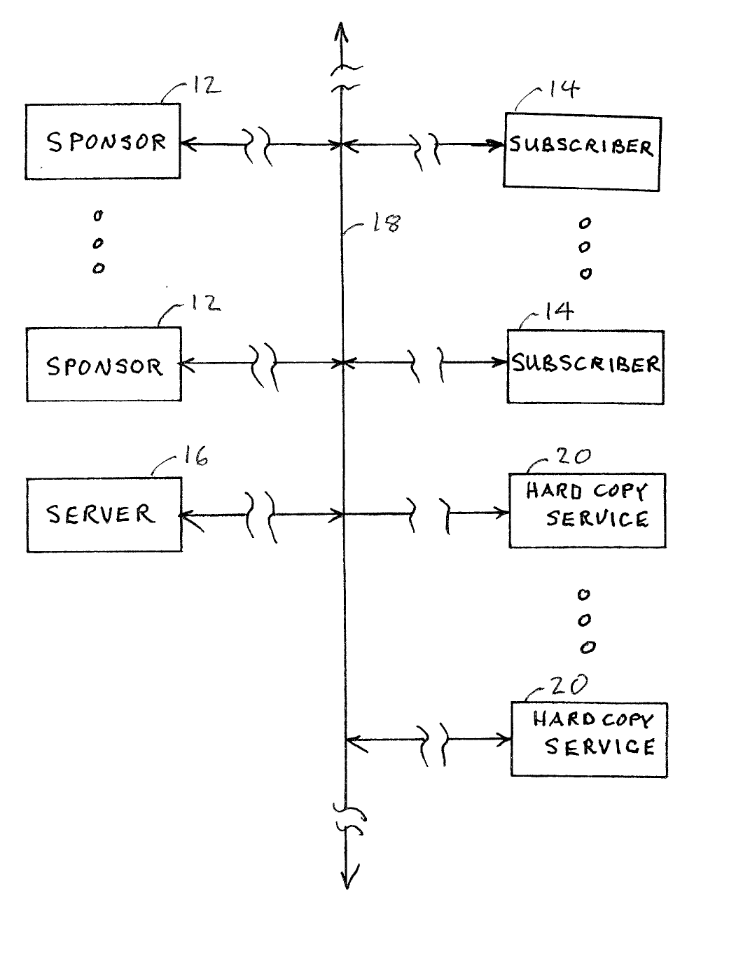

### BACKGROUND OF THE INVENTION

The present invention relates to the distribution of project information for bidding in the construction industry and, in particular, to the distribution of such information over an international public computer communications network.

The construction industry is commonly composed of interlocking hierarchies of owners, architects, developers, construction managers, general contractors, contractors, subcontractors, suppliers and vendors. In order to function, plans and specifications must be consulted so that bids and proposals may be submitted. Typically, each level in the hierarchy will be familiar with only a limited number of entities above and/or below that level. As a result, project information (and resulting bids) will usually only flow between entities that are familiar with one another. This tends to limit the ability of an entity to establish new relationships, especially in a new geographic area.

Another obstacle to adding new relationships is the sheer burden of the paper and administrative tasks involved in giving each entity the project information necessary to bid on and perform the desired tasks or supply the required material and equipment. In large projects, hundreds of pages of project information must flow to dozens of contractors, subcontractors, suppliers and vendors. Even a small project may be sent out to a dozen bidders.

In addition to being administratively inefficient and costly, this situation is not conducive to low bids. Typically prices rise with a lack of competition and fall where there are many entities at each level competing for business.

### SUMMARY OF THE INVENTION

A method for distributing project information includes posting respective project information from a plurality of sponsors on an international public computer communications network, permitting a subscriber to access selected portions of the respective project information to determine a desired sponsor and a desired portion of the respective project information, registering a subscriber with the desired sponsor for distribution of the desired portions of the respective project information and permitting the registered subscriber to access the desired portions of the respective project information.

### BRIEF DESCRIPTION OF THE DRAWINGS

The FIGURE is a block diagram of a project information system suitable for performing a method according to the invention.

### DESCRIPTION OF THE EMBODIMENTS

Referring to the FIGURE, a system 10 for distributing project information is shown. Sponsors 12, subscribers 14 and a server 16 are interconnected by a network 18. Hard copy services 20 are also connected to the network 18.

The network 18 is an international public computer communications network, for example, the network commonly referred to as the “Internet”. The system 10 can advantageously use the well-known tools and resources available to such a network, e.g., TCP/IP, HTML, XTML, FTP, SMTP, POP3, Java Script, Java Language, Java Virtual Machines, Web Browsers and Servers, E-Mail Clients and Servers, FTP Clients and Servers, etc. The network 18 may also include proprietary portions such as intranets that are in turn connected to the Internet.

A sponsor 12 is an entity desiring to distribute project information to the subscribers 14. Project information may be, for example, construction plans and specifications or other information that is desirable for the successful completion of a project. The sponsors 12 may be, for example, an owner, architect, developer, construction manager, or general contractor. The subscribers 14 may be, for example, contractors, subcontractors, suppliers or vendors.

The hard copy services 20 are entities (e.g., blue print houses, print shops and copy centers) that can provide the subscribers 14 with hard copies of the project information, particularly large format items such as blue prints or large volume copies of other project information.

The server 16 manages the flow of project information. This function can be centralized in a single server as shown or portions may be distributed across the network 18 as desired.

In one implementation of the method of the invention, the server 16 includes a web server as the main interface between the sponsors 12, the subscribers 14 and the hard copy services 20.

A sponsor 12 desiring to distribute project information posts the information on the server 16. The information may be actually copied to the server 16, or just links to the information may be included on the server 16, with the actual information continuing to reside at the sponsor 12. The project information includes not only the complete information, but also a selected portion of the information that is available to all subscribers 14.

In one implementation of the method of the invention, the subscribers 14 access the selected portion of the information with a web browser. The subscribers 14 may simply browse through the selected portions of the respective project information of the sponsors 12. The selected portion of the project information may include, for example, sponsor, Construction Specifications Institute (CSI) category, geographical area, project size, project type and time frame such as due date.

In another implementation of the method of the invention, the subscribers 14 may request the server 16 to filter and/or sort the selected portion of the project information on the basis of one or more of the items in the selected portion, such as sponsor, CSI category, geographical area, project size, project type and time frame.

If a subscriber 14 desires to access the complete information for a desired project of a sponsor 12, the subscriber 14 registers through the server 16 with the desired sponsor 12. If the sponsor 12 approves of the access, the subscriber 12 is permitted to access the complete information for the desired project of the sponsor 12.

Using this method greatly simplifies the administrative burdens of sponsors and subscribers firstly finding each other and secondly exchanging the necessary project information. A subscriber 14 may view projects regardless of area, type or size and download plans and specifications at any time of the day or night. More bidders with lower transactional costs results in lower bids and more opportunities for establishing business relationships.

In addition, once a subscriber 14 is registered with a sponsor 14 for a project, the subscriber can easily be made aware of any later changes to the project information. The subscriber 14 may be, for example, e-mailed to check the server 16 for updates. “Push” techniques may also be used to automatically move the updates to the subscriber 14.

This saves the administrative burden of preparing hard copy update packages for all of the subscribers and manually making sure that they are sent to the necessary subscribers.

While most subscribers will have a simple printer. Hard copies of project information such as blue prints or large volume printing may be a challenge for many subscribers.

In another implementation of the method of the invention, hard copy services 20 are identified to the subscribers 14 by the server 16. If desired, the registered subscribers are permitted to not only access the desired portions of the respective project information themselves, but also, to direct at least a portion of the information to a hard copy service 20 for physical copies.

The use of the network 18 to transfer the project information between entities greatly improves the efficiency of communication. It allows many different sponsors to interact with many different subscribers in an efficient and low cost manner. It should also be noted that the cited examples of sponsors and subscribers are somewhat arbitrary in that in some cases sponsor may wish also to be subscribers and vice versa.

While method of the invention has all of the above-cited advantages, it is desirable to have a business model that pays for its implementation.

In another implementation of the method of the invention, the entity represented by the server 16 charges the sponsors 12 for posting the respective project information on the network 18. The sponsors 12 will typically have the most interest in increasing the number of bidders and lowering the bids. In addition, it may be desirable to charge no fee to the subscribers 14 to encourage maximum participation.

When the subscribers 14 direct information to a hard copy service 20, it is expected that the subscriber 12 pay for the service.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A method for distributing project information, said method comprising:
posting respective project information from a plurality of sponsors on an international public computer communications network;
permitting a subscriber to access selected portions of said respective project information via said international public computer communications network to determine a desired sponsor and a desired portion of said respective project information;
registering a subscriber with said desired sponsor via said international public computer communications network for distribution of said desired portions of said respective project information; and
permitting said registered subscriber to access said desired portions of said respective project information via said international public computer communications network.

2. A method according to claim 1, wherein said subscriber accesses said selected portions of said respective project information on the basis of at least one of sponsor, CSI category, geographical area, project size, project type and time frame.

3. A method according to claim 1, further comprising notifying said subscriber of later changes in said desired portions of said respective project information via said international public computer communications network.

4. A method according to claim 1, further comprising:
identifying a hard copy service to said registered subscriber via said international public computer communications network; and
permitting said registered subscriber to direct at least a portion of said desired portions of said respective project information to said hard copy service via said international public computer communications network.

5. A method for distributing project information, said method comprising:
charging a plurality of sponsors to post respective project information on an international public computer communications network;
permitting a subscriber to access selected portions of said respective project information via said international public computer communications network to determine a desired sponsor and a desired portion of said respective project information;
registering a subscriber with said desired sponsor via said international public computer communications network for distribution of said desired portions of said respective project information; and
permitting said registered subscriber to access said desired portions of said respective project information via said international public computer communications network.

6. A method according to claim 5, wherein said subscriber accesses said selected portions of said respective project information on the basis of at least one of sponsor, CSI category, geographical area, project size, project type and time frame.

7. A method according to claim 5, further comprising notifying said subscriber of later changes in said desired portions of said respective project information via said international public computer communications network.

8. A method according to claim 5, further comprising:
identifying a hard copy service to said registered subscriber via said international public computer communications network; and
permitting said registered subscriber to direct at least a portion of said desired portions of said respective project information to said hard copy service via said international public computer communications network.

9. A method according to claim 5, wherein said subscriber pays no fees to be permitted to access said respective project information.

10. A method according to claim 7, wherein said subscriber pays said hard copy service for said directed at least a portion of said desired portions of said respective project information.
